(19) United States
(12) Patent Application Publication
(10) Pub. No.: US 2004/0079743 A1
(43) Pub. Date: Apr. 29, 2004

(54) Rearview mirror defrost indicator

(76) Inventor: Tommy E. White, Rochester Hills, NY (US)

Correspondence Address: CHRISTOPHER DEVRIES, General Motors Corporation, Legal Staff, Mail Code 482-C23-B21, P.O. Box 300, Detroit, MI, 48265-3000, US

(21) Appl. No.: 10/281,912

(22) Filed: Oct. 28, 2002

(51) Int. Cl. B60L 1/02

(52) U.S. Cl. 219/202; 219/219; 359/512; 340/425.5

(57) ABSTRACT

A vehicle is provided with an external mirror which is, in turn, equipped with a defroster. Means are provided for displaying a visual indication on the mirror when the defroster is activated. When a driver operates a manual switch within the vehicle, current is supplied from the vehicle's source of potential to the defroster and to the display means causing it to display an appropriate symbol or symbols.

### TECHNICAL FIELD

This invention relates generally to defrosters, and more particularly to a rearview mirror defroster and defrost indicator for use on a vehicle such as an automobile.

### BACKGROUND OF THE INVENTION

The provision of rear view mirrors including external, side mounted mirrors for use on automobiles and the like is generally well known. More specifically, externally mounted side rearview mirrors which include a reflective element or glass mirror are typically mounted on the exterior of most vehicles and are considered useful in the safe operation and maneuverability of the vehicle. This being the case, there are certain circumstances under which the utility of exterior mounted mirrors may be compromised. For example, low temperatures and adverse weather conditions, such as snow, ice, and sleet can significantly reduce the utility of an external rearview mirror and thus a driver's visibility.

More specifically, when the temperature of a mirrored surface falls below the dew point of the surrounding air, the reflective surface can become fogged or obscured. Additionally, the mirror can no longer fulfill its function properly if it is covered with ice and/or snow. Furthermore, in locations having relatively humid climates, external mirrors may become less useful if and when the humidity should precipitate as condensation on the mirror's surface.

In an effort to overcome some of the above mentioned problems, mirror defrosters have been developed. These defrosters may include an electrical heating element arranged adjacent to an inner surface of the mirror. Positive temperature coefficient (PTC) heaters used in these mirrors may include a substrate having an electrically resistive layer of material. Known defrosters are generally activated by the driver of the vehicle and are used to provide a certain level of heat to the surface of the mirror. Thus, the vehicle's driver may selectively engage or disengage the heating feature or defroster as necessary to accommodate various driving conditions such as exposure to reduce temperatures and driving in otherwise inclement weather.

While the use of the heated mirror defrosters has been generally successful in increasing the usability of mirrors under certain conditions, other issues have arisen. For example, a driver may intentionally activate the mirror's defroster when driving conditions so dictate and then forget to turn the defroster off when driving conditions improve or when arriving at the driver's destination. Accordingly, even when the heating or defrosting feature is no longer necessary, the mirrors may remain heated while the operator of the vehicle remains unaware of the defroster's continued operation. Sometimes, a driver may inadvertently or unintentionally activate the mirror's defroster. Once again, the operator may be unaware that the mirrored defroster has been activated and as a result, the defroster may remain activated for an extended period of time. In either situation, the unintentional operation of the mirror defroster is considered undesirable. At the very least, continuous or unintentional operation of the mirror's defroster over long periods of time may result in premature failure of the defroster. In some cases, an indicator is mounted on the vehicle's dashboard to provide an indication to the operator that the defroster is currently operational; however, since the indicator is typically not in the operator's field of view, this indicator is oftentimes overlooked by drivers.

One such mirror defrosting assembly is shown and described in U.S. Pat. No. 6,316,706 issued Nov. 13, 2001 and entitled “Defrosting Assembly For A Mirror Of A Vehicle”. This apparatus includes a transparent planer sheet and an electrical wire that has a medial portion which is coupled to the transparent planer sheet. This planer sheet may be adhesively coupled to the mirror. The electrical wire is designed to carry an electrical current therethrough which results in heating the wire and therefore defrosting the mirror.

Thus, it should be appreciated that it would be desirable to provide a rearview mirror defrosting system which inherently provides means for reducing the inadvertent operation of the defroster.

### SUMMARY OF THE INVENTION

According to an aspect of the invention, there is provided a defrosting system for defrosting an externally mounted mirror assembly. A defroster, which may comprise at least one heating element, is configured to defrost the surface of the mirror. Means are provided for activating the defroster and activating a display means which displays a visual indication on the mirror. In this manner, the operator of the vehicle is made aware that the defroster has been made operational by the presence of the visual indication on the mirror.

### BRIEF DESCRIPTION OF THE DRAWINGS

The present invention will hereinafter be described in conjunction with the following drawing figures, wherein like numerals denote like elements, and

FIG. 1 illustrates an automobile having an external rearview mirror;

FIG. 2 illustrates a rearview mirror in accordance with the present invention; and

FIG. 3 is a schematic diagram illustrating the inventive mirror defroster and display.

### DESCRIPTION OF THE PREFERRED EMBODIMENT

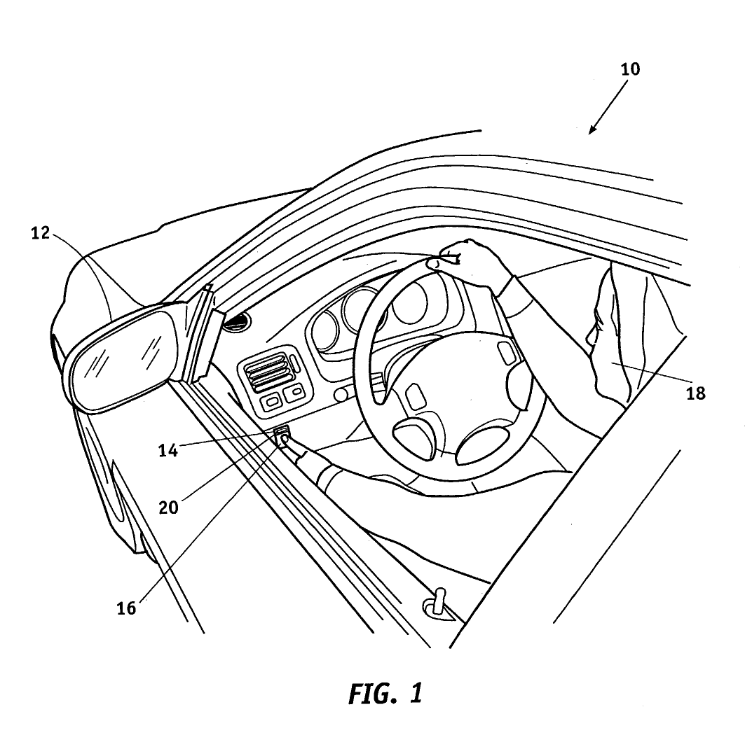

Referring to FIG. 1, there is shown a vehicle 10 such as an automobile that is equipped with an external side mounted rearview mirror 12. A first control mechanism 14 (e.g., a push button switch) may be activated by an operator 18 of vehicle 10 in order to activate a defroster (for example of the type described above) which is associated with mirror 12. A second control mechanism (e.g., a push button switch) 16 may be activated by operator 18 to turn the defroster off. As stated previously, operator 18 may fail to deactivate the defroster associated with mirror 12 even though driving conditions may not warrant its continued operation. Even if, for example, a visual indicator 20 were provided on control mechanism 14 to indicate that the defroster has been activated, this indicator could easily be ignored by operator 18 since it is not in the operator's normal line of sight when operating the vehicle.

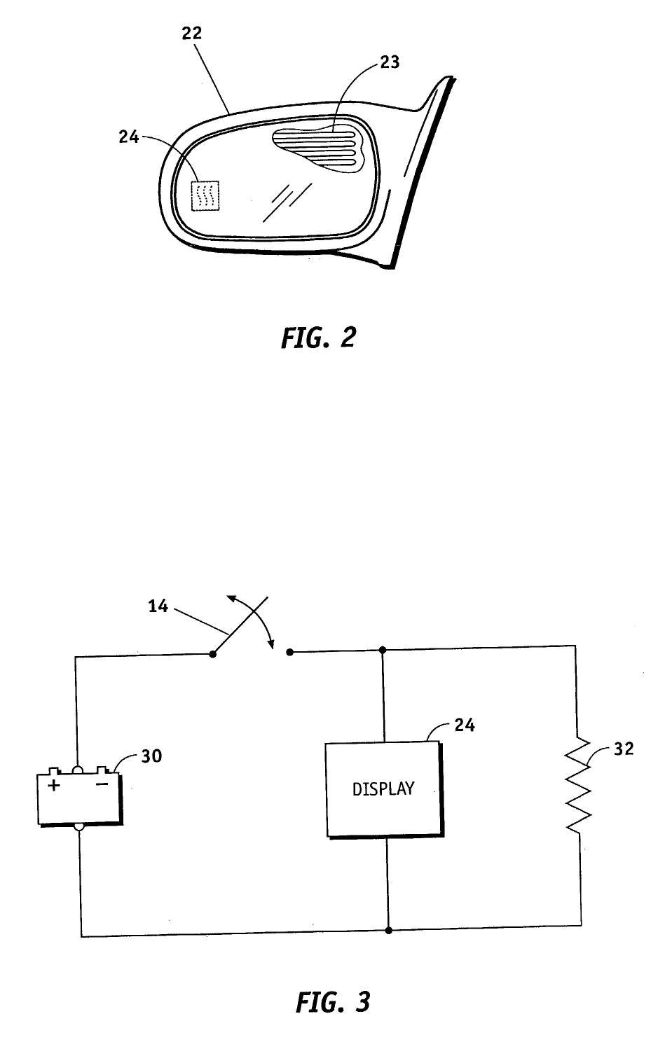

Referring now to FIG. 2, there is shown a mirror 22 equipped with a defrosting element 23 in accordance with a preferred exemplary embodiment of the present invention. Mirror 22 includes one or more visual indicators 24 that are activated whenever the defroster's heating element 23 is activated. Indicator 24 may be a light emitting diode (LED) located just beneath the mirrored surface layer of mirror 22.

It should be noted that visual indicator 24 shown in FIG. 2 is merely representative of any number of visual indicators that may be included in mirror 22 to indicate to the operator of the vehicle that the heating or defrosting function of mirror 22 has been activated and is currently operational. The exact configuration of visual indicator 24, including shape and color, may vary in accordance with a desired specific application. For example, an international organization for standardization (ISO) icon may be incorporated into a visual indicator. Furthermore, a specific color, such as red, may be chosen to achieve a desired effect.

FIG. 3 is a schematic diagram of the inventive mirror defroster apparatus. As can be seen, a battery 30 represents a vehicle's source of electrical power. When control switch 14 (also shown in FIG. 1) is closed, a circuit is completed which causes current to flow through resistor 32 which is representative of the heating elements in the mirror defroster. Current is likewise applied to visual indicator or display 24 so as to activate the display and indicate that the defroster is operational. The signal required to activate visual indicator 24 may be transmitted via a physical wire or as some form of wireless signal using radio frequency or other transmission means.

In operation, if operator 18 activates control switch 14, whether intentionally or unintentionally, the heating elements of the mirror defroster will be energized as will visual indicator 24. Since most drivers continually refer to and rely on the vehicle's rearview mirrors when driving, the driver will be alerted if the defroster has been inadvertently activated or continues to be activated when conditions do not warrant. Additionally, visual indicator 24 provides positive feedback assuring the operator that the defroster has been successfully activated.

Mirrors capable of providing a visual indication are well known. For example, one known arrangement for displaying data on a mirror surface includes at least one light emitting element and a corresponding light guide having a first end-face coupled to receive light from the light emitting element and a second end-face located substantially parallel to the mirror surface. The mirror surface is provided with a light transmissive aperture in the region of the second end phase. For a further discussion of mirrors capable of displaying data, the interested reader is directed to U.S. Pat. No. 5,631,638 issued May 20, 1997 and entitled “Information System in a Motor Vehicle”; U.S. Pat. No. 5,634,709 issued Jun. 3, 1997 and entitled “Inner Mirror of a Vehicle Having a Display Device”; U.S. Pat. No. 6,099,154 issued Aug. 8, 2000 and entitled “Mirror with Lighted Indicia”; and U.S. Pat. No. 6,200,010 issued Mar. 13, 2001, entitled “Display Arrangement For a Motor Vehicle”, the teachings of which are hereby incorporated by reference.

Thus, there has been provided a vehicular mirror defrosting system wherein a visual indication is visible on the mirror surface indicating to the driver that the defroster is activated. In this manner, the operator of the vehicle is alerted if the defroster has been inadvertently activated or current circumstances do not warrant its continued activation. Both the driver and the manufacturer are provided with a convenient mechanism for determining that the defrost system is operational thus eliminating the need for unnecessary repairs and the costs related thereto.

While certain elements have been presented in the foregoing detailed description of the preferred exemplary embodiments, it should be appreciated that a vast number of variations in the embodiments exist. For example, while only a single mirror 12 is depicted on the operator's left side as shown in FIG. 1, vehicle mirrors may be utilized in other locations and display one or more visual indicators indicating that their respective defrosters are operational. It should also be appreciated that the preferred exemplary embodiments are only examples, and are not intended to limit the scope, applicability, or configuration of the invention in any way. Rather, the foregoing detailed description provides those skilled in the art with a convenient roadmap for implementing the preferred exemplary embodiment. It should also be understood that various changes may be made in the function and arrangement of elements described in the exemplary preferred embodiment without departing from the spirit and scope of the invention as set forth in the appended claims.

1. A defrosting system for use on a vehicle, said defrosting system comprising:
an external mirror assembly coupled to said vehicle, said external mirror assembly comprising at least one mirror;
a defroster configured to defrost said at least one mirror;
first means for activating said defroster; and
display means for displaying a visual indication on said at least one mirror when said defroster is operating.

2. A system according to claim 1 wherein said at least one mirror includes a mirrored surface on which said visual indication appears.

3. A system according to claim 2 wherein said defroster includes at least one heating element proximate said mirrored surface.

4. A system according to claim 3 wherein said vehicle includes a source of potential and wherein said first means comprises a switch assembly for electrically coupling said source to said at least one heating element.

5. A system according to claim 4 wherein said switch assembly electrically couples said display means to said source.

6. A system according to claim 5 wherein said switch assembly is a manually-operated switch.

7. A system according to claim 6 wherein said visual indication is an icon.

8. A mirror assembly for use on a vehicle, said mirror assembly comprising:
a reflective surface;
at least one heating element dispose proximate said reflective surface; and
first means for generating a visual indication on said mirror assembly when said at least on heating element is activated.

9. An assembly according to claim 8 wherein said visual indication appears through said reflective surface.

10. An assembly according to claim 9 wherein said reflective surface has an optically transmissive portion through which said visual indication appears.

11. An assembly according to claim 10 wherein said at least one heating element and said first means are activated by a manually-operable switch.

12. An assembly according to claim 11 wherein said visual indication is an icon.

13. A mirror assembly for use on a vehicle, said mirror assembly comprising:
a mirrored surface;
a defroster for defrosting said mirrored surface; and
display means for generating a visual indication that said defroster is operating, said indication being visible through said mirrored surface.

14. An assembly according to claim 13 wherein said defroster comprises:
at least one heating element;
a source of potential on said vehicle; and
a switching element for coupling said at least one heating element to said source.

15. An assembly according to claim 14, wherein said switching element is a manually-operable switch.

16. An assembly according to claim 15 wherein said manually-operable switch couples said display means to said source.
